(19) United States
(12) Patent Application Publication
(10) Pub. No.: US 2002/0069364 A1
(43) Pub. Date: Jun. 6, 2002

(54) Internet terminal with identification module

(75) Inventor: Franz A. Dosch, Rosenheim (DE)

Correspondence Address: MICHAEL BEST & FRIEDRICH, LLP, 100 E WISCONSIN AVENUE, MILWAUKEE, WI, 53202, US

(73) Assignee: Dosch & Amand GmbH & Co. KG, Muenchen (DE)

(21) Appl. No.: 09/909,470

(22) Filed: Jul. 19, 2001

(30) Foreign Application Priority Data
Jul. 19, 2000 (DE) 20012538.9

(51) Int. Cl. H04L 9/32

(52) U.S. Cl. 713/200

(57) ABSTRACT

An internet terminal (11) comprising:

a touch-sensitive display (12) and

a means (13) for communication with a connectable identification module (15),

wherein

the terminal (11) receives configuration data from the identification module (15) for a connection to the internet (21).

The present invention relates to an internet terminal and an identification module (subscriber information module, SIM) for use with the internet terminal. In particular, the invention relates to a mobile internet terminal, hereinafter also called WebPad, and a chip card, hereinafter also called SmartCard.

A growing interest of computer users in the internet results in computers which are specifically adapted to the internet. These special computers, hereinafter also called internet terminals, are to enable a user to use the internet in a way which is as simple and intuitive as possible.

According to the prior art an internet terminal comprises e.g. a keyboard with specific keys or a computer mouse with an additional wheel, such means simplifying navigation in the internet. Other internet terminals according to the prior art comprise a touch-sensitive display permitting navigation by direct selection on the display. To take into account an increasing mobility of the users, internet terminals become portable and cordless. Such mobile internet terminals are compact and substantially flat and are therefore also designated as WebPads.

Computers in general and internet terminals, in particular, are more and more equipped with a pre-installed operating system and pre-installed application programs to save a time-consuming and troublesome installation of the programs for the user. The programs are configured with standard settings which are to be suited for the majority of the users.

However, the use of the computers and internet terminals still requires from a user that he makes corresponding changes in the configuration. For instance, settings on an internet browser and for a connection to the internet must be carried out for an internet terminal. The connection to the internet comprises a physical connection to an internet service provider and a logic connection via the internet service provider in the internet. The physical connection comprises, for instance, an interface between the computer or internet terminal and a public telephone network via which a connection is established to the internet service provider. To permit a connection of the computer to the public telephone network, both the connection of the computer to the interface and the connection of the interface to the public telephone network must be configured in a correct way. The connection to the internet service provider requires, for instance, a telephone number of the internet service provider, an identification of the user and a password. It is comprehensible that technical knowledge and many different pieces of information are needed for the correct establishment of a connection; because of this, it is difficult, if not impossible—in particular for a user who is not familiar with the use of the internet—to make the necessary settings himself.

It is thus the object of the invention to provide devices which reduce the efforts for the configuration of a computer, in particular of an internet terminal, and thus to simplify the establishment of a connection to the internet considerably.

This object is achieved by the subject matters of the independent claims 1 and 10 according to the invention. Preferred embodiments of the invention are subject matters of the dependent claims.

According to a first aspect of the invention even a technically inexperienced user can use internet services without any trouble.

According to a second aspect the connection to a pre-defined internet service provider can be established automatically and without any action on the user's part to make only those services available to the user that are offered by this internet service provider.

According to a third aspect the connection to a pre-defined internet portal can be carried out automatically and without any action on the user's part for providing the user only with the information that is accessible via this internet portal.

According to a fourth aspect an unauthorized or undesired access to the internet or the internet portal by third parties can be prevented.

According to the invention the connection to the internet is accomplished by an internet terminal with a means for communication with a connectable identification module and an identification module with configuration data for the connection of the internet terminal to the internet, the internet terminal receiving configuration data from the identification module for the connection. The internet terminal is preferably designed as a WebPad. The internet terminal can comprise a touch-sensitive display as well as a means for wireless communication, preferably according to the DECT (Digital European Cordless Telecommunication) standard, with a base station, the internet terminal establishing the connection to the internet via the means for wireless communication. Furthermore, the internet terminal can establish the connection automatically after communication with the identification module. The internet terminal can establish the connection via an internet service provider determined by the configuration data. Furthermore, the internet terminal can activate itself automatically for communication with the identification module when the identification module is coupled to the internet terminal, e.g. by insertion of the identification module into the internet terminal. Furthermore, the internet terminal can establish the connection exclusively after communication with an identification module which contains key data enabling the internet terminal. The identification module can be designed as a contact-type chip card or as a contactless transponder. The identification module may contain access data to an internet service provider, subscriber data identifying a user of the internet terminal, key data enabling the internet terminal, service data specifying the enabled services of the internet service provider, payment data permitting a remuneration for the connection and services, credit data permitting an actual accounting of the connection and services, and coding data for protecting the connection.

According to the invention it can further be ensured by means of the identification module that the connection of the internet terminal to the internet can take place exclusively via a predetermined internet service provider or that exclusively predetermined information services are provided. Thus the risk of theft can be reduced for the internet terminal on the one hand because the provision of a suitable identification module is necessary and on the other hand the use of a specific internet service provider can be defined for the internet terminal, whereby a partial or complete financing of the internet terminal is made possible by the internet service provider.

The unauthorized or undesired access to the internet or an internet portal by third parties is prevented by removing the identification module from the internet terminal.

An imitation of an identification module is e.g. prevented or at least rendered very difficult by an authorization code (software dongle) which is matched to the internet terminal.

Advantages as well as preferred embodiments of the invention shall now be explained in more detail with reference to the attached drawings which show in detail in

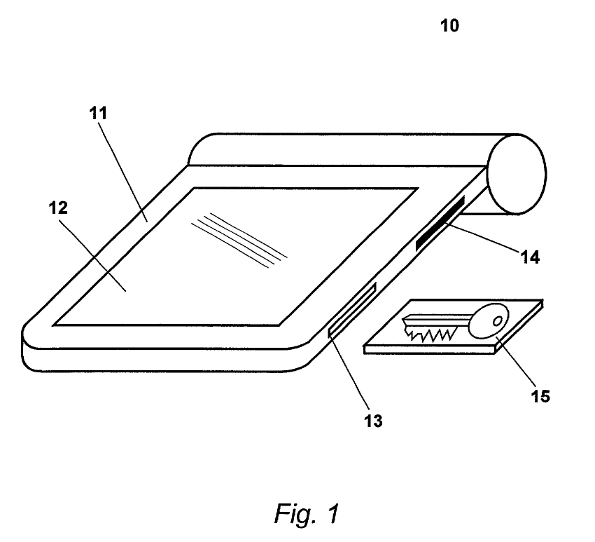

FIG. 1 a schematic representation of an internet terminal, which according to a preferred embodiment is designed as a WebPad, and of an identification module, which according to a preferred embodiment is designed as a chip cart;

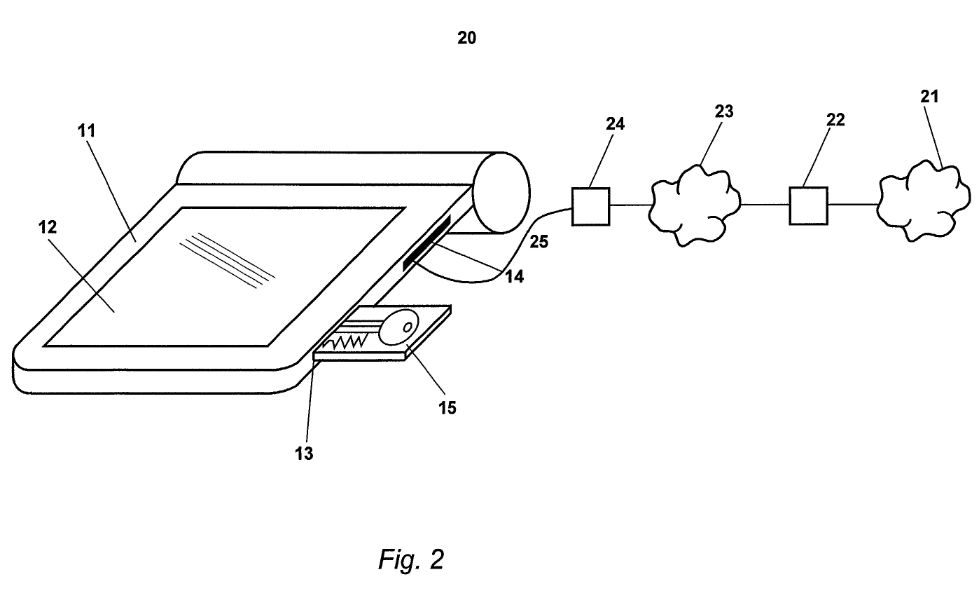

FIG. 2 a schematic representation of the connection of the internet terminal according to the preferred embodiment to the internet via a cord-bound connection to a public telephone network;

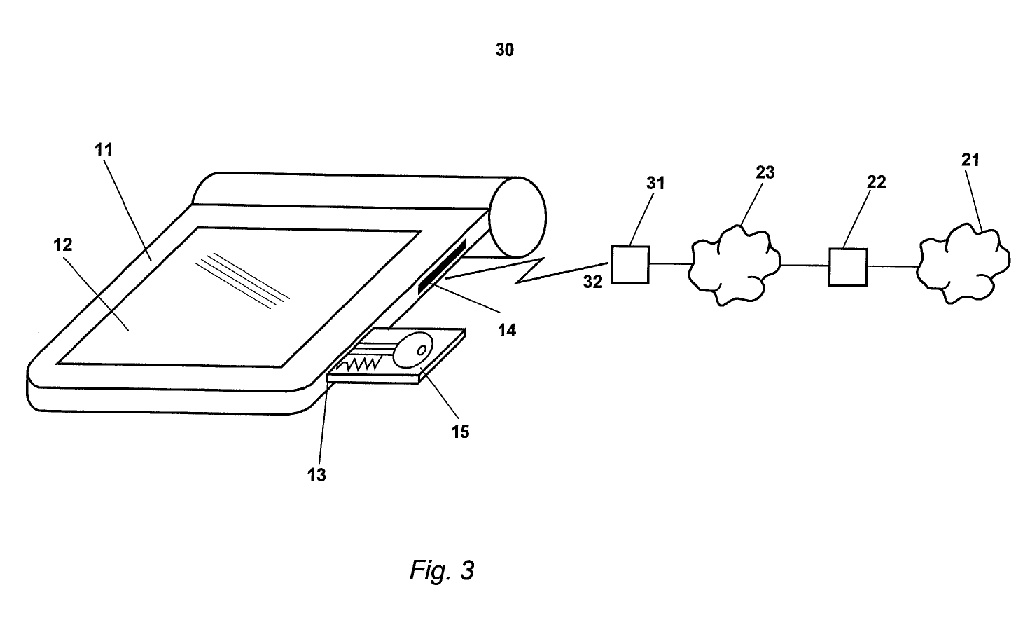

FIG. 3 a schematic representation of the connection of the internet terminal according to the preferred embodiment to the internet via a cordless connection to the public telephone network;

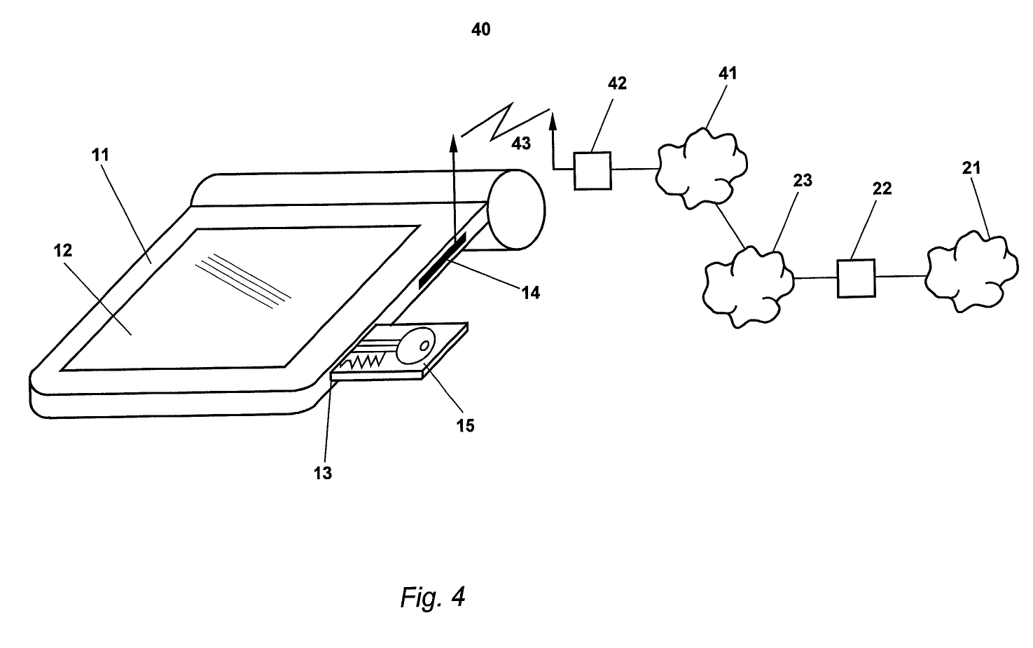

FIG. 4 a schematic representation of a mobile connection of the internet terminal according to the preferred embodiment to the internet via a mobile telephone network;

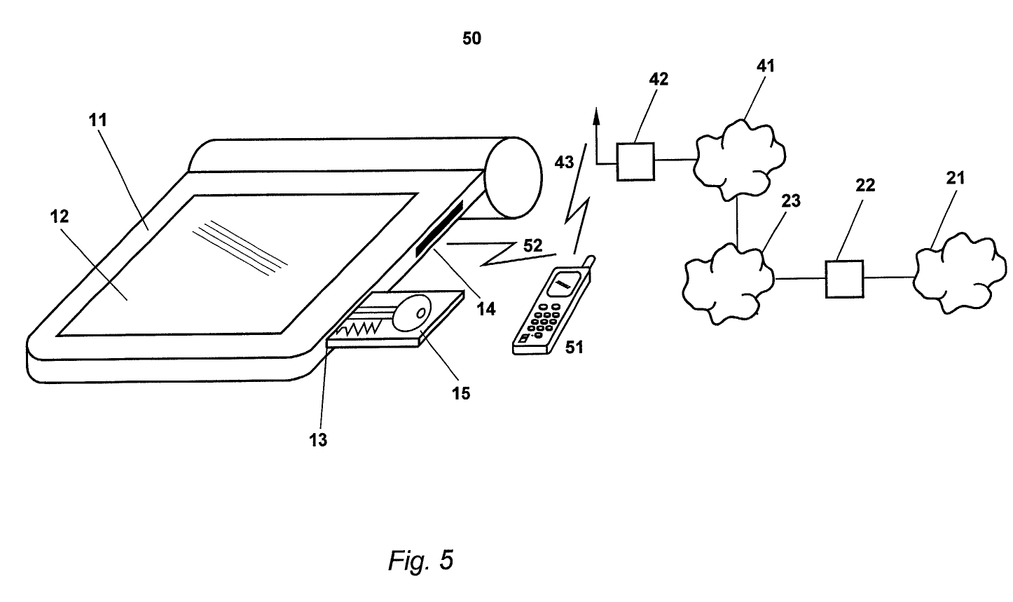

FIG. 5 a schematic representation of the mobile connection of the internet terminal according to the preferred embodiment to the internet via the mobile telephone network by means of a mobile telephone, and

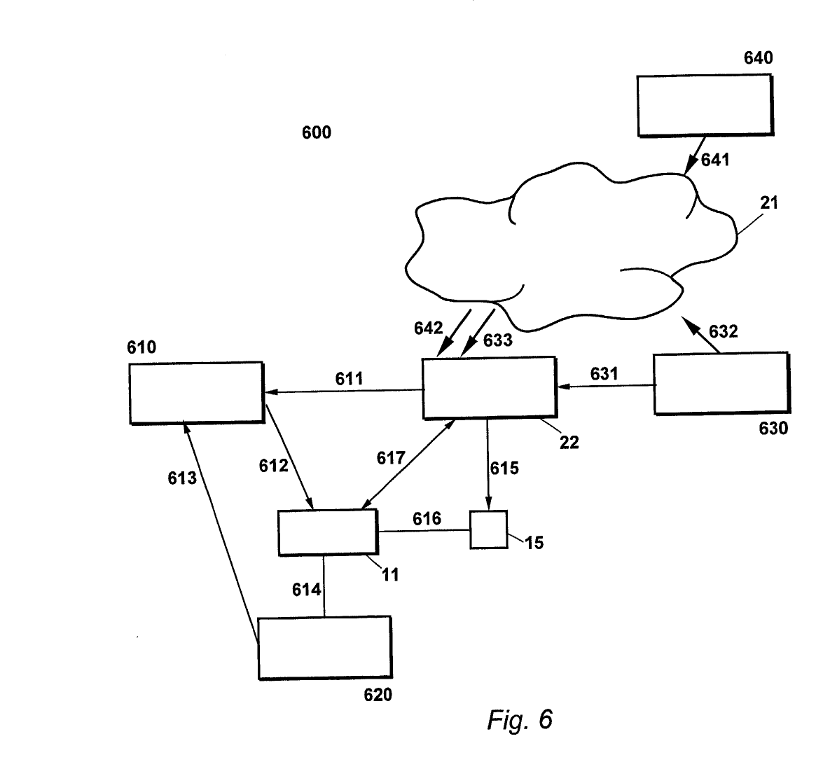

FIG. 6 a schematic representation for illustrating a system for distributing the internet terminal according to the preferred embodiment by subsidizing the internet terminal.

FIG. 1 shows a system 10 comprising the internet terminal 11 and the identification module 15 according to the preferred embodiment of the invention. The internet terminal 11 comprises a touch-sensitive display 12, a means 13 for communication with the connectable identification module 15 and a means 14 for communication. As shown in FIG. 1, the touch-sensitive display 12 is surrounded in the manner of a frame by a housing of the internet terminal 11. Thus a user can place the internet terminal 11 in front of him, for instance on a table, and study the contents of the display 12. A slight inclination of the display 12 is possible by giving the housing a corresponding shape, whereby the readability of the display 12 can be improved.

The means 13 for communication with the identification module 15 is designed such that the internet terminal 11 can receive configuration data from the identification module 15. The design of the means 13 for communication with the identification module 15 depends on the features of the identification module 15. In the preferred embodiment the identification module 15 is designed as a contact-based chip card, resulting in corresponding dimensions and arrangements of contacts for the means 13 for communication with the identification module 15. Alternatively, the identification module 15 may be designed as a contactless transponder, e.g. as a radio-frequency identification module (RFID). The transponder, which is also designated as a contactless chip card, permits an easier handling, is of a more robust design and less prone to failure. Since transponders have a certain range of communication, it is not necessary to insert the transponder 15 into the means 13 for communication for transmitting the configuration data into the internet terminal 11.

The means 14 serves as an interface between the internet terminal 11 and a communication network which permits connection to the internet. The communication network may be a public fixed telephone network or a mobile telephone network. Alternatively, the internet terminal 11 may be connected via the means 14 to a computer network, such as a local network (local-area network, LAN) or a wide-area network (WAN). The design of the means 14 depends on the features of the respective communication network. The means 14 may alternatively be a conventional serial, parallel or USB (universal serial bus) interface, or the like, and the connection to the, for instance, public fixed telephone network may be established via a modem. The public fixed telephone network may either be an analog or a digital and, in particular, an ISDN telephone system.

The internet terminal 11 further comprises a processor and a memory. A non-volatile part of the memory accommodates an operating system, for instance based on Linux, and an internet browser. Preferably, the internet terminal comprises an operating system which starts instantaneously (instant-on operating system). The internet terminal 11 further comprises a power supply which is preferably designed as an accumulator. Moreover, the internet terminal 11 may comprise a means for receiving operating power, for instance, from an external power supply. Furthermore, the internet terminal 11 may comprise interfaces, a means for charging the accumulator, disk memory, camera and other conventional computer means.

The identification module 15 contains, preferably in encoded form, configuration data for the connection of the internet terminal 11 to the internet. The configuration data may be arranged in the communication module 15 in blocks. A first block contains the access data to the internet provider; the access data comprise customer number, user identity number, access code, personal identification number (PIN) and telephone number of the dial-in node with portal selection. A second block contains data on contents and services; the data comprise general information selection, personal information selection, general service selection, personal service selection and information about the personal mail server. A third block contains authorization data; the authorization data comprise a terminal identification number and an identification-module identification number. Preferably, the identification module 15 additionally contains an encoded authorization code (software dongle) which prevents or makes difficult the use of imitated or unauthorized identification modules. The authorization code is matched with the internet terminal 11.

The system 10 for the configuration of the internet terminal 11 by means of the identification module 15 may be integrated into an existing chip card system; for instance, the identification module 15 may be part of a chip card for authentication, e.g. a cash card. Furthermore, the identification module 15 may contain configuration data which serve, for instance, the authentication of the user in the internet, e.g. for online orders and online payments. The identification module 15 may further contain configuration data which make it possible to encode the data transmitted via the connection to the internet.

FIG. 2 shows a system 20 with a cord-bound connection to the public telephone network 23. The internet terminal 11 contains a conventional serial interface 14 which is connected via a serial line 25 to a conventional modem 24. The modem 24 is connected to the public telephone network 23 which can be analog or digital. The internet terminal 11 is connected to the internet 21 via an internet service provider 22 connected to the public telephone network 23. When the identification module 15 is coupled with the means 13 for communication, the internet terminal 11 receives the configuration data required for establishing a connection to the internet 21 from the identification module 15. The connection to the internet 21 supports, e.g., the receipt and transmission of electronic letters (emails) and surfing the World Wide Web. In one embodiment a connection to the internet is first established via a portal of the internet service provider 22, i.e. a start page with contents of the internet service provider 22. In the preferred embodiment the connection to the internet exists exclusively via said portal, so that the internet service provider 22 has at least a partial influence on the contents shown on the display 12.

The internet terminal 11 can automatically set up the connection after communication with the identification module 15. The connection to the internet 21 is established via the service provider 22 determined by the configuration data. Since the internet terminal 11 sets up the connection exclusively after communication with an identification module 15 containing key data that enable the internet terminal 11, it can be ensured that the connection to the internet 21 is exclusively established via the predetermined internet service provider 22. The communication between the internet terminal 11 and the communication module 15 takes place in accordance with a predetermined mechanism. The mechanism may comprise a one-way authentication in the case of which either the internet terminal 11 legitimizes itself vis-à-vis the identification module 15 or the identification module 15 vis-à-vis the internet terminal 11. Alternatively, the mechanism may comprise a mutual authentication in the case of which the internet terminal 11 and the identification module 15 legitimize one another. The authentication may e.g. use symmetrical or asymmetrical coding methods. A terminal/module pair can be formed by the mutual authentication so that a specific internet terminal 11 can exclusively be enabled via a specific identification module 15.

FIG. 3 shows a system 30 which is e.g. suited for use at home or in the office, the system comprising a cordless connection to the public telephone network 23. According to this embodiment the interface 14 is suited for wireless communication 32 with a base station 31. The wireless communication 32 may e.g. take place in an optical way, i.e. by means of light or wireless, i.e. by means of radio waves. The range of the communication 32 is adapted to the range of motion of the user. While the range for an optical communication 32 may be limited to a few centimeters or meters, it can be in the order of 100 m for a radio communication 32. In the case of the optical communication 32 infrared light may e.g. be used. The radio communication 32 may preferably take place according to the DECT standard. The DECT DMPA standard is particularly suited for the communication 32 between the internet terminal 11 and the base station 31 which is connected to the public telephone network. Alternatively, the interface 14 and the base station 31 may be designed according to the Bluetooth specification for the wireless communication of data and language.

While the interface 14 may be completely integrated into the internet terminal, the interface 14 in the preferred embodiment is designed as a PCMCIA (personal computer memory card international association) or PC card or the like, so that the interface 14 can be exchanged by the user without any problems. Thus the user can select the respectively suited wire-bound or wireless interface 14 and use the same with the internet terminal 11.

FIG. 4 shows a mobile system 40 suited for use e.g. in a cellular mobile telephone network 41. The interface 14 is e.g. designed according to the GSM (global system for mobile communications) standard or the UMTS (universal mobile telecommunications system) standard and can establish a wireless connection 43, i.e. a telephone connection, to a base station 42 of the mobile telephone network 41. The connection to the internet can be direct via the internet service provider 22 or, as shown in FIG. 4, via the public telephone network 23 and the internet service provider 22.

FIG. 5 shows a further mobile system 50 in which the connection to the internet 21 is again established via the mobile telephone network 41. The system 50 comprises a mobile telephone 51 which is e.g. designed according to the GSM standard or the UMTS standard and suited for communication 43 with the base station 42 of the mobile telephone network 41. The communication 52 between the internet terminal 11 and the mobile telephone 51 takes place, in a way similar to that described with reference to FIG. 3, via radiowaves or light. To this end the interface 14 and the mobile telephone 51 are designed according to the Bluetooth specification. Since the communications 43 and 52 are wireless, a high mobility and flexibility are achieved in this embodiment.

FIG. 6 illustrates the use of the internet terminal 11 and of the identification module 15 in a commercial system 600. A producer 610 produces the internet terminal 11 which passes 612 directly or via a trading or sales partner to the user 620. The producer 610 expects an adequate profit for the internet terminal 11. An internet service provider 22 offers the user 620 access to the internet 21. This access to the internet 21 may entail costs or be free of charge for the user 620. An access subject to costs may e.g. be charged for the duration of the access or optionally e.g. via a monthly basic rate, or as a flat rate.

Alternatively, the access to the internet 21 may be fully or partly financed by advertisements. For instance, when the user 620 calls information 641 of an information provider (content provider) 640 during a connection with the internet 21, this information is transmitted to the user 620 via the internet 21 and the internet service provider 22. The internet service provider 22 has reached an agreement with an advertiser 630 that the internet service provider 22 transmits advertisement 633 of the advertiser 630 together with the information 642 to the user 620, the advertiser 630 feeding the advertisement 632 into the internet 21. In return, the internet service provider 22 expects an adequate remuneration 634 from the advertiser 630. Alternatively, the advertiser 630 may send the advertisement 632 directly to the internet service provider 22.

Since the internet service provider 22 passes on 611 part of its revenue from the access, which is possibly to be paid for, and, possibly, advertisement-related remuneration to the producer 610, the remuneration 613 given by the user 620 in return for the internet terminal 11 to the producer 610 can be reduced or omitted altogether.

The internet service provider 22 which has financed the internet terminal 11 of the user 620 fully or in part will give the identification module 15 to the user 620 to ensure that the user 620 uses 614 the internet terminal 11 only for the connection 617 via its service. Since the internet terminal 11 establishes the connection 617 to the internet 21 only via the internet service provider 22 in combination 616 with the identification module 15, another improper use of the internet terminal is prevented.

In an alternative embodiment the identification module 15 may contain configuration data which apart from the internet service provider 22 also identify the information provider 640 so that the information provider 640 can be further integrated into the system.

Thus the system 600 of the invention supports a method for providing an internet service 22 to a user 620, the method comprising: assigning an identification module 15 to an internet terminal 11 and the internet service 22, the identification module 15 being suited for enabling the internet terminal 11 and for connecting the internet terminal 11 to the internet service 22, providing the internet terminal 11 and the identification module 15 for the user 620, providing the internet service 22 via the internet terminal 11 to the user 620 on condition that the internet terminal 11 is enabled by the identification module 15, and financing the internet terminal 11, based on the use of the internet service 22 by the user 620. Furthermore, the method may comprise blocking access to the internet 21 in case the internet terminal 11 is not enabled by the identification module 15. Furthermore, the method may comprise blocking access to other internet services. Furthermore, the step of providing the internet service 22 to the user 620 may comprise providing advertisement 632, 633 of an advertiser 630 for the user 620 within the internet service 22 and the step of financing, debiting the advertiser 630, for providing the advertisement 632 to the user 620 within the internet service 22. Furthermore, the method may comprise the step of producing the internet terminal 11 by a producer 610, and the step of financing may at least in part form the basis for the payment of the selling price of the producer for the internet terminal 11.

1. An internet terminal (11) comprising:
a touch-sensitive display (12) and,
a means (13) for communication with a connectable identification module (15),
wherein
the terminal (11) receives configuration data from the identification module (15) for a connection to the internet (21).

2. The internet terminal (11) according to claim 1, wherein the terminal (11) is designed as a WebPad.

3. The internet terminal (11) according to claim 1 or 2, further comprising:
a means (14) for the wireless communication, preferably according to the DECT standard, with a base station (31),
wherein
the terminal (11) sets up the connection via the means (14) for wireless communication.

4. The internet terminal (11) according to any one of claims 1 to 3, wherein the terminal (11) sets up the connection automatically after communication with the identification module (15).

5. The internet terminal (11) according to any one of claims 1 to 4, wherein the terminal (11) sets up the connection via an internet service provider (22) determined by the configuration data.

6. The internet terminal (11) according to any one of claims 1 to 5, wherein the terminal (11) activates itself automatically for communication with the identification module (15) when the identification module (15) is coupled to the terminal (11).

7. The internet terminal (11) according to any one of claims 1 to 6, wherein the terminal (11) sets up the connection only after communication with an identification module (15) which contains key data enabling the terminal (11).

8. The internet terminal (11) according to any one of claims 1 to 7, wherein the identification module (15) is designed as a chip card.

9. The internet terminal (11) according to any one of claims 1 to 7, wherein the identification module (15) is designed as a transponder.

10. The identification module (15) comprising:
configuration data for a connection of an internet terminal (11) to the internet (21).

11. The identification module (15) according to claim 10, wherein the configuration data comprise:
access data to an internet service provider (22).

12. The identification module (15) according to claim 10 or 11, wherein the configuration data comprise:
subscriber data identifying a user of the terminal (11).

13. The identification module (15) according to any one of claims 10 to 12, wherein the configuration data comprise:
key data which enable the terminal (11).

14. The identification module (15) according to any one of claims 10 to 13, wherein the configuration data comprise:
service data which specify enabled services.

15. The identification module (15) according to any one of claims 10 to 14, wherein the configuration data comprise:
payment data permitting a remuneration for the connection.

16. The identification module (15) according to any one of claims 10 to 15, wherein the configuration data comprise:
credit data which permit an actual accounting of the connection.

17. The identification module (15) according to any one of claims 10 to 16, wherein the identification module (15) is designed as a chip card.

18. The identification module (15) according to any one of claims 10 to 16, wherein the identification module (15) is designed as a transponder.

19. An internet-based system (60) for disseminating information via a specific service provider (22) to a subscriber, wherein:
the specific service provider provides access to the internet (21) and an identification module (15) according to any one of claims 10 to 18;
the subscriber obtains data representative of the information via the access and evaluates the data by means of an internet terminal (11) according to any one of claims 1 to 9; and
the internet terminal (11) obtains access to the internet (21) only in combination with the identification module (15) of the specific service provider.
